(19) United States
(12) Patent Application Publication
(10) Pub. No.: US 2011/0319119 A1
(43) Pub. Date: Dec. 29, 2011

(54) USER APPARATUS AND MOBILE COMMUNICATION METHOD

(75) Inventor: Hiroyuki Ishii, Kanagawa (JP)

(73) Assignee: NTT DOCOMO, INC., Tokyo (JP)

(21) Appl. No.: 13/142,337

(22) PCT Filed: Dec. 25, 2009
(86) PCT No.: PCT/JP2009/071603

§ 371 Date: Sep. 15, 2011

(30) Foreign Application Priority Data
Dec. 26, 2008 (JP) 2008-335052
Nov. 6, 2009 (JP) 2009-255586

(51) Int. Cl. H04W 52/04

(52) U.S. Cl. 455/522

(57) ABSTRACT

A user apparatus (100ₙ) according to the present invention includes: a maximum transmission power control unit (1083) configured to receive a control signal designating a frequency band in a downlink; and to control a maximum transmission power in a predetermined channel of an uplink; wherein the maximum transmission power control unit (1083) is configured to determine whether or not to decrease the maximum transmission power in a predetermined channel from a rated power regulated in the mobile communication system, according to the frequency band designated by the control signal.

### TECHNICAL FIELD

The present invention relates to a technical field of mobile communications, and more particularly, the present invention relates to a user apparatus in a mobile communication system using a next-generation mobile communication technology and a mobile communication method therefor.

### BACKGROUND ART

A group aiming to achieve standardization, the 3GPP, is working on a specification for the LTE (Long Term Evolution) (E-UTRA) scheme, i.e., a communication scheme that will be next-generation communication scheme of the Wideband-Code Division Multiple Access (W-CDMA) scheme, the High Speed Downlink Packet Access (HSDPA) scheme, the High Speed Uplink Packet Access (HSUPA) scheme and so on.

As a radio access scheme of the LTE scheme, the OFDMA (Orthogonal Frequency Division Multiplexing Access) scheme is adopted for a downlink, and the SC-FDMA (Single-Carrier Frequency Division Multiple Access) scheme is adopted for an uplink (see the Non-patent Literature 1, for example).

The OFDMA scheme is a multicarrier transmission scheme in which a frequency band is divided into a plurality of narrow frequency bands (sub-carriers) and data is loaded on the sub-carriers for transmission. According to the OFDM scheme, the sub-carriers are orthogonalized on the frequency axis and densely arranged, as a result of which it is expected that high-rate transmission can be achieved and frequency use efficiency can be improved.

The SC-FDMA scheme is a single carrier transmission scheme in which a frequency band is divided for each terminal and frequency bands different among a plurality of terminals are used for transmission. According to the SC-FDMA scheme, it is possible to easily and effectively reduce the interference among user apparatuses, and in addition, it is possible to lessen the variation of transmission power. Therefore, it is said that the

SC-FDMA scheme is preferable in terms of low power consumption, broad coverage, etc., of the user apparatus.

In the mobile communication system of the LTE scheme, one or at least two resource blocks are assigned to the user apparatus both in the downlink and uplink, and then, the communication is performed. In this case, the resource block is shared by one or at least two user apparatuses within the mobile communication system.

A base station apparatus is configured to determine to which user apparatus the resource block is assigned, out of one or at least two user apparatuses, for each sub-frame (in the LTE scheme, each 1 ms) (such process is referred to as “scheduling”).

In the downlink, the base station apparatus is configured to transmit a shared channel signal to the user apparatus selected in the scheduling by using one or at least two resource blocks.

In the uplink, the user apparatus selected in the scheduling is configured to transmit a shared channel signal to the base station apparatus by using one or at least two resource blocks.

Then, in the mobile communication system using a shared channel as described above, it is necessary to perform signaling about the assignment of the aforementioned shared channel to any particular user apparatus for each sub-frame (in the LTE scheme, for each 1 ms).

A control channel used for such signaling is referred to as “PDCCH (Physical Downlink Control Channel)” or “downlink L1/L2 control channel (DL-L1/L2 Control Channel)” in the LTE scheme.

In information on such a physical downlink control channel, “Downlink Scheduling Information”, “Uplink Scheduling Grant”, etc., are mapped.

It is noted that above-described downlink scheduling information or uplink scheduling grant is also referred to as “DCI (Downlink Control Information)”. For example, the “DCI format 0” corresponds to the uplink scheduling grant, and the “DCI format 1”, the “DCI format 1A”, the “DCI format 2”, etc., correspond to the downlink scheduling information (see the Non-patent Literatures 1 and 2, for example).

The above-described downlink scheduling information or uplink scheduling grant corresponds to information for performing signaling about the assignment of the above-described shared channel to any particular user apparatus.

In the above-described downlink scheduling information, “assignment information of a resource block of a downlink”, “ID (C-RNTI) of UE”, “the number of streams”, “information about Precoding Vector”, “data size”, “modulation scheme”, “information about HARQ (hybrid automatic repeat request)”, etc., relating to the downlink shared channel, are included.

On the other hand, in the above-described uplink scheduling grant, “information about assignment of a resource of an uplink”, “ID (C-RNTI) of UE”, “data size”, “modulation scheme”, “transmission power control command of an uplink”, “information on Demodulation Reference Signal”, etc., relating to the shared channel of the uplink, are included.

Now, in mobile communication systems that use radio waves, such as mobile telephone, wave astronomy, satellite communications, aviation and sea radar, earth resources survey, and wireless LAN, frequency bands to be utilized are generally separated to prevent interference with each other.

Further, for example, the frequency band assigned to the mobile telephone system is further used by a plurality of mobile communication systems, and the frequency band used in each mobile communication system is separated.

For example, in FIG. 15, a usage situation of frequency bands from 1884.5 MHz to 1980 MHz in Japan is illustrated.

As illustrated in FIG. 15, the frequency bands from 1920 MHz to 1980 MHz are to be assigned to the uplink of the LTE scheme. Further, in the frequency bands smaller than 1920 MHz, specifically, in frequency bands from 1884.5 MHz to 1919.6 MHz, the PHS system is operated.

It is noted that the above-described frequency bands from 1920 MHz to 1980 MHz are defined as “E-UTRA Band 1” in the 3GPP (see FIG. 5 described later).

That is, in the mobile communication system using radio waves, the frequency band used is separated, and thereby, interference between systems is prevented.

However, a transmitter that emits radio waves emits an unnecessary wave (hereinafter, referred to as “adjacent channel interference”) to a frequency band outside the frequency band used by the transmitter, and therefore, even if the frequency band used among the mobile communication systems is separated, a plurality of adjacent mobile communication systems interfere with each other. Thus, when the power level of the above-described unnecessary wave is large, a severe adverse effect is imposed on the adjacent mobile communication system.

In order to prevent the adverse effect on the adjacent mobile communication system caused by such an adjacent channel interference, a characteristic relating to the above-described adjacent channel interference or a Spurious emission is defined in each mobile communication system.

For example, in the above-described mobile communication system of the LTE scheme, a regulation relating to the ACLR (Adjacent Channel Leakage power Ratio) of a user apparatus or the

Spurious emission exists in the “3GPP TS36.101 6.6 Output RF spectrum emissions (Non-patent Literature 3)”.

To change a subject slightly, in order to inhibit the unnecessary wave to outside the frequency band used by the above-described mobile communication system, it is necessary for the user apparatus to install a power amplifying machine (power amplifier) having a high linearity.

Thus, given the cost or the size of the user apparatus, it is sometimes difficult to reduce the above-described unnecessary wave or satisfy the regulation of the above-described ACLR or the regulation of the Spurious emission.

In this case, for example, in the above-described Non-patent Literature 3, the “operation in which the maximum transmission power may be reduced” under a certain condition is defined to inhibit the cost or the size of the user apparatus.

For example, in the Non-patent Literature 3, the “MPR (Maximum Power Reduction)” based on a modulation scheme such as QPSK and 16QAM or a transmission frequency bandwidth determined by the number of resource blocks is defined (see the “Table 6.2.3-1”). Such MPR corresponds to the above-described “operation in which the maximum transmission power may be reduced”.

Moreover, for example, in the “Table 6.2.4-1” of the Non-patent Literature 3, the “additional MPR (A-MPR)” based on a certain operation scenario is defined.

For example, as illustrated in FIG. 15, in the frequency bands from 1884.5 MHz to 1980 MHz in Japan, the A-MPR corresponding to the “Network Signalling value: NS_{—}05” is introduced so as to realize inhibition of the cost and the size of the user apparatus and maintaining of the power of the Spurious emission to the PHS band to a regulated value or less.

It is noted that the above-described “Network Signalling value” is notified from the base station apparatus to the user apparatus by way of broadcast information or a handover command. Such “Network Signalling value” is defined as an information element, i.e., the “additionalSpectrumEmission” in the Non-patent Literature 4.

### Citation List

### Non-Patent Literature

Non-patent Literature 1: 3GPP TS36.211 (V. 8.4.0) , “E-UTRA Physical Channels and Modulation”, September 2008

Non-patent Literature 2: 3GPP TS36.212 (V.8.4.0), “E-UTRA Multiplexing and channel coding”, September 2008
Non-patent Literature 3: 3GPP TS36.101 (V.8.3.0), “E-UTRA User Equipment (UE) radio transmission and reception”, September 2008
Non-patent Literature 4: 3GPP TS36.331 (V.8.3.0), “E-UTRA RRC; Protocol specification”, September 2008

However, the above-described conventional technologies have the following problems:

For example, the situation of the frequency bands from 1884.5 MHz to 1980 MHz in Japan, as illustrated in FIG. 15, differs from that in regions other than Japan, e.g., North America and Europe, and therefore, it is possible to appropriately operate an operation according to the situation of each region because of the A-MPR corresponding to the “Network Signalling value”.

For example, in Japan, when the “Network Signalling value: NS_{—}05” is notified, the power of the Spurious emission to the PHS band is kept to the regulated value or less, and when the “Network Signalling value: NS_{—}01” is notified in the regions other than Japan where the PHS band does not exist, an operation in which an unnecessary reduction of the maximum transmission power is avoided is possible.

That is, in the frequency band used in a plurality of regions in the world such as the above-described “E-UTRA Band 1 (1920 to 1980 MHz)”, the A-MPR corresponding to the “Network Signalling value” is introduced so that the appropriate operation according to each region is possible.

On the other hand, in the frequency band defined in the LTE scheme, a frequency band defined only in a certain region exists. For example, the “E-UTRA Band 6 (uplink: 830 to 840 MHz, downlink: 875 to 885 MHz)” defined in the Non-patent Literature 3 is operated only in Japan.

In this case, even when the “Network Signalling value” is not used, the user apparatus can communicate by using such a frequency band in a certain region, and as a result, it is possible to appropriately operate the A-MPR.

In other words, in the frequency band defined in the above-described certain region, there is a problem that the above-described “Network Signalling value” becomes a redundant information element.

Therefore, the present invention is intended to overcome the above-described problem. An object of the present invention is to provide a user apparatus capable of flexibily reducing an amount of interference to an adjacent system frequency band based on a control signal designating a frequency band used in a mobile communication system, and to provide a mobile communication method therefor.

### SUMMARY OF THE INVENTION

A first aspect of the present invention is summarized as a user apparatus that performs a radio communication with a base station apparatus within a mobile communication system, including: a reception unit configured to receive a control signal designating a frequency band in a downlink; and a maximum transmission power control unit configured to control a maximum transmission power in a predetermined channel of an uplink; wherein the maximum transmission power control unit is configured to determine whether or not to decrease the maximum transmission power in a predetermined channel from a rated power regulated in the mobile communication system, according to the frequency band designated by the control signal.

A second aspect of the present invention is summarized as a mobile communication method in which a radio communication is performed between a base station apparatus and a user apparatus within a mobile communication system, including the steps of:

(A) receiving, at the user apparatus, a control signal designating a frequency band in a downlink; and (B) controlling, at the user apparatus, a maximum transmission power in a predetermined channel of an uplink; and in the step (B), the user apparatus determines whether or not to decrease the maximum transmission power in a predetermined channel from a rated power regulated in the mobile communication system, according to the frequency band designated by the control signal.

As described above, according to the present invention, it is possible to provide a user apparatus capable of flexibily reducing an amount of interference to an adjacent system frequency band based on a control signal designating a frequency band used in a mobile communication system, and to provide a mobile communication method therefor.

### BRIEF DESCRIPTION OF THE DRAWINGS

FIG. 1 is a diagram showing the entire configuration of a mobile communication system according to a first embodiment of the present invention.

FIG. 2 is a functional block diagram of a base station apparatus according to the first embodiment of the present invention.

FIG. 3 is a functional block diagram of a mobile station according to the first embodiment of the present invention.

FIG. 4 is a functional block diagram of a baseband signal processing unit of the mobile station according to the first embodiment of the present invention.

FIG. 5 is a table illustrating one example of a frequency band used in the mobile communication system according to the first embodiment of the present invention.

FIG. 6 is a table illustrating one example of an A-MPR table used in the mobile communication system according to the first embodiment of the present invention.

FIG. 7 is a table illustrating one example of the A-MPR table used in the mobile communication system according to the first embodiment of the present invention.

FIG. 8 is a table illustrating one example of the A-MPR table used in the mobile communication system according to the first embodiment of the present invention.

FIG. 9 is a table illustrating one example of the MPR table used in the mobile communication system according to the first embodiment of the present invention.

FIG. 10 is a diagram illustrating one example of an equation used when the mobile station according to the first embodiment of the present invention determines a transmission power in PUSCH.

FIG. 11 is a diagram illustrating one example of an equation used when the mobile station according to the first embodiment of the present invention determines a transmission power in PUCCH.

FIG. 12 is a diagram illustrating one example of an equation used when the mobile station according to the first embodiment of the present invention determines a transmission power in a channel for SRS.

FIG. 13 is a diagram illustrating one example of an equation used when the mobile station according to the first embodiment of the present invention determines a transmission power in PRACH.

FIG. 14 is a flowchart illustrating an operation of the mobile station according to the first embodiment of the present invention.

FIG. 15 is a diagram illustrating a usage situation of a frequency band in Japan.

### DETAILED DESCRIPTION

### (Mobile Communication System According to a First Embodiment of the Present Invention)

With reference to drawings, a mobile communication system according to a first embodiment of the present invention will be explained. In all the drawings for explaining the embodiment, the same reference numerals are assigned to components having the same function, and a repeated explanation will be omitted.

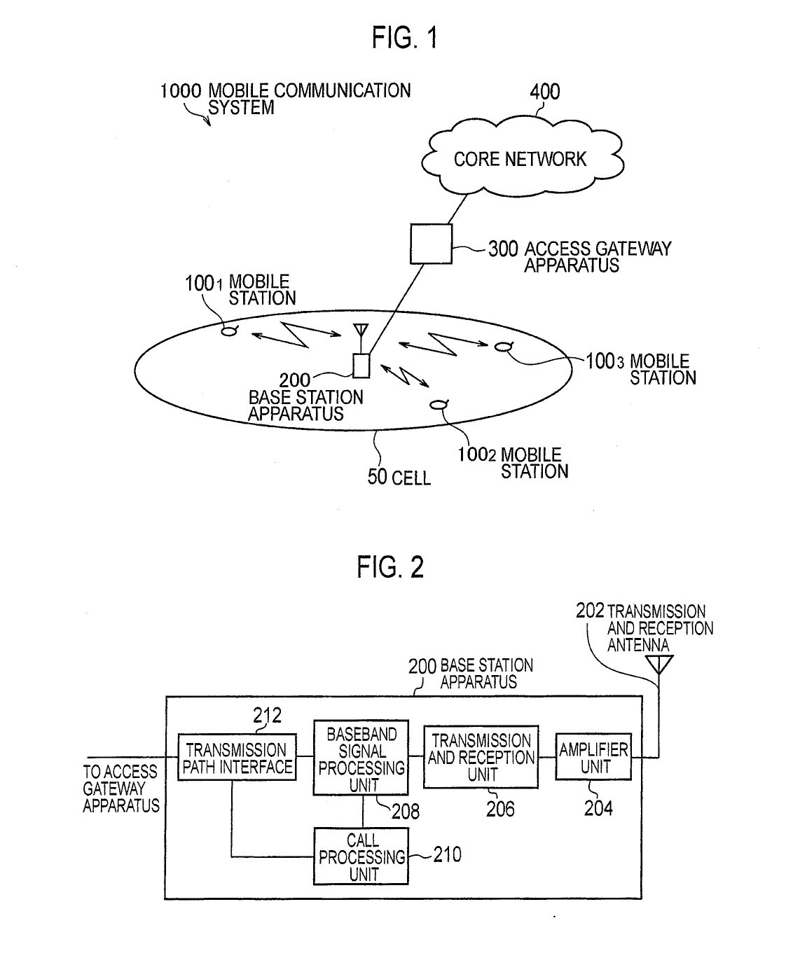

With reference to FIG. 1, a mobile communication system having a user apparatus and a base station apparatus according to this embodiment will be explained.

A mobile communication system 1000 is a system to which the “Evolved UTRA and UTRAN (referred also to as the “Long Term Evolution” or the “Super 3G”)” scheme, for example, is applied.

The mobile communication system 1000 includes abase station apparatus (eNB: eNode B) 200, and a plurality of user apparatuses (UE: User Equipment) 100ₙ (100₁, 100₂, 100₃, 100ₙ, (n is an integer larger than 0)) which communicate with the base station apparatus 200.

The base station apparatus 200 is connected to an upper station, e.g., an access gateway apparatus 300, and the access gateway apparatus 300 is connected to a core network 400. The user apparatus 100ₙ communicates with the base station apparatus 200 in a cell 50 by using the “Evolved UTRA and UTRAN” scheme. It is noted that access gateway apparatus 300 may also be referred to as an MME/SGW (Mobility Management Entity/Serving Gateway).

Each user apparatus (100₁, 100₂, 100₃, 100ₙ) has the same configuration, function, and state, and thus, the description below is such that each user apparatus is called a user apparatus 100ₙ unless otherwise specified. For simplicity, an apparatus used for the radio communication with the base station apparatus is treated as a user apparatus; it should be noted that the user apparatus according to the present invention includes a mobile terminal and a fixed terminal.

As the radio access system in the mobile communication system 1000, the “OFDMA (Orthogonal Frequency-Division Multiple Access) scheme” is applied to the downlink, and the “SC-FDMA (Single-Carrier-Frequency-Division Multiple Access) scheme” is applied to the uplink.

As described above, the OFDMA scheme is a multicarrier transmission scheme in which a frequency band is divided into a plurality of narrow frequency bands (sub-carriers) and data is mapped to each sub-carrier for communication. On the other hand, the SC-FDMA scheme is a single carrier transmission system in which the frequency band is divided to each terminal and a plurality of user apparatuses use respectively different frequency bands so that interference among the user apparatuses is reduced.

At this time, a communication channel used for the “Evolved UTRA and UTRAN” scheme is explained.

For the downlink, a “physical downlink shared channel (PDSCH)” and a “physical downlink control channel (PDCCH)” that are shared by each user apparatus looₙ are used.

By the PDSCH (Physical Downlink Shared Channel), user data, i.e., a normal data signal, is transmitted. Further, information on an ID of a user apparatus that communicates by using the PDSCH or a transport format of user data (i.e., downlink scheduling information), information on an ID of user who communicates by using the PUSCH (Physical Uplink Shared Channel) or a transport format of user data (i.e., uplink scheduling grant), etc., are notified by way of PDCCH.

PDCCH may also be referred to as “Downlink L1/L2 Control Channel”. Further, the “downlink scheduling information” or the “uplink scheduling grant” may also be collectively referred to as “downlink control information (DCI)”.

Further, in the downlink, a “BCCH (Broadcast Control Channel)” is transmitted as a logical channel.

One portion of the BCCH is mapped to a “BCH (Broadcast Channel) ” which is a transport channel, and the information mapped to the BCH is transmitted to the user apparatus looₙ within the corresponding cell by way of a “P-BCH (Physical Broadcast Channel)” which is a physical channel.

Moreover, one portion of the BCCH is mapped to a “DL-SCH (Downlink Shared Channel)” which is a transport channel, and the information mapped to the DL-SCH is transmitted to the user apparatus 100ₙ within the corresponding cell by way of a “PDSCH” which is a physical channel.

A broadcast channel transmitted by the BCCH/DL-SCH/PDSCH may also be referred to as “dynamic broadcast channel (D-BCH)”.

It is noted that as an information element transmitted by the BCCH, a control signal designating a frequency band is notified. For example, as an information element of one portion of a “SIB (System Information Block Type 1)” which is one of BCCH signals, a control signal designating such a frequency band, i.e., a “frequencyBandIndicator” may be notified. Such “frequency Band Indicator” may also be referred to as “freq Band Indicator”.

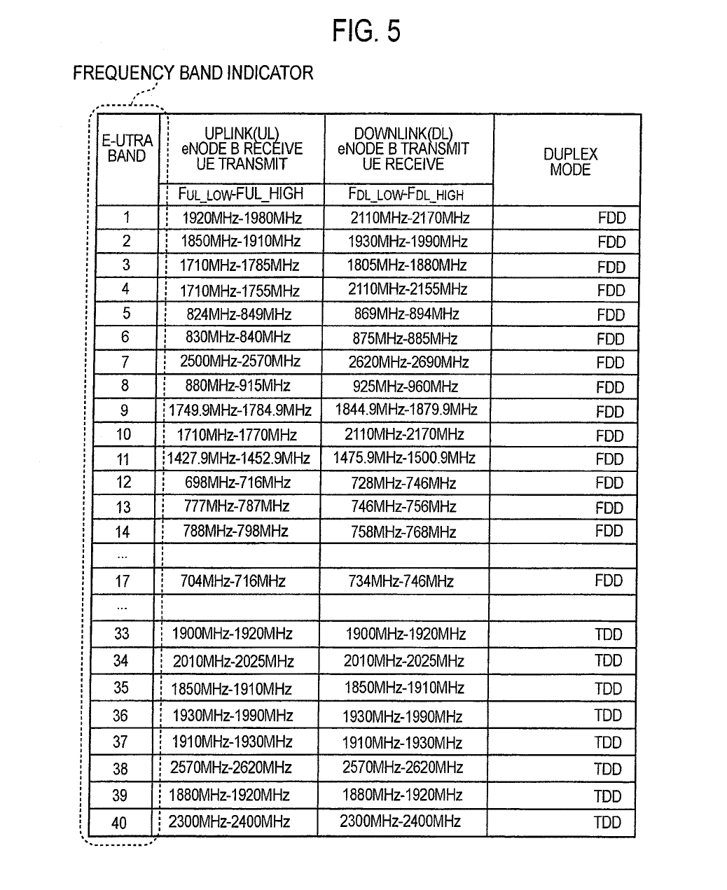

It is noted that specifically, the “frequency Band Indicator” may be an index “E-UTRA Band” present in the leftmost column of a table illustrated in FIG. 5. The table illustrated in FIG. 5 is defined in the above-described Non-Patent Literature 3.

It is noted that the above-described frequency band indicator may be notified from the base station apparatus 200 to the user apparatus 100ₙ by way of an RRC message. In this case, the RRC message may be a “Handover Command”, for example, which is the RRC message instructing Handover. It is noted that the RRC message is a “DCCH (Dedicated Control Channel)” as a logical channel.

Alternately, the above-described frequency band indicator may be notified from the base station apparatus 200 to the user apparatus 100ₙ by way of the RRC message at a time of starting the communication.

When the user apparatus 100ₙ receives the control signal designating the frequency band included in the BCCH, i.e., the “frequencyBandIndicator”, the user apparatus 100ₙbecomes capable of knowing that any particular frequency band is used in the corresponding cell.

It is noted that the control signal designating the frequency band may be notified to the user apparatus 100ₙ as one portion of the information element of a system information block other than the above-described SIB1.

For the uplink, the PUSCH and the PUCCH used and shared by each user apparatus 100ₙ are used. By way of such PUSCH, the user data, i.e., a normal data signal, is transmitted.

Further, by way of PUCCH downlink quality information or CQI (Channel Quality Indicator) used for a scheduling process and the AMCS (Adaptive Modulation and Coding Scheme) of the PDSCH, and transmission confirmation information (i.e., Acknowledgement Information) of the PDSCH are transmitted.

A content of such Acknowledgement Information is expressed by either ACK (Acknowledgement) indicating that a transmission signal is appropriately received or NACK (Negative Acknowledgement) indicating that the transmission signal is not appropriately received.

It is noted that when a timing at which the above-described CQI or Acknowledgement Information is transmitted coincides with that at which the PUSCH is transmitted, such CQI or Acknowledgement Information may be multiplexed and transmitted on the PUSCH.

With reference to FIG. 2, the base station apparatus 200 according to this embodiment is explained, below.

The base station apparatus 200 includes a transmission and reception antenna 202, an amplifier unit 204, a transmission and reception unit 206, a baseband signal processing unit 208, a call processing unit 210, and a transmission path interface 212.

The user data transmitted from the base station apparatus 200 to the user apparatus 100ₙ by way of the downlink is input from a upper station located upper than the base station apparatus 200, e.g., the access gateway apparatus 300, to the baseband signal processing unit 208 via the transmission path interface 212.

In the baseband signal processing unit 208, such user data is subjected to various processes such as a PDCP-layer transmission process, an RLC-layer transmission process including a segmentation-and-concatenation process and an RLC (radio link control) retransmission control process, an MAC (Medium Access Control) retransmission control process, e.g., a transmission process of an HARQ (Hybrid Automatic Repeat reQuest), a scheduling process, a transmission format selection process, a channel coding process, and an IFFT (Inverse Fast Fourier Transform) process, and then, transferred to the transmission and reception unit 206.

Further, a DCCH signal that is an RRC message is also subjected to a transmission process such as a channel coding process and an inverse fast fourier transform process, and then, transferred to the transmission and reception unit 206.

Further, a PDCCH signal that is a downlink control channel is also subjected to a transmission process such as a channel coding process and an inverse fast fourier transform process, and then, transferred to the transmission and reception unit 206.

Moreover, the baseband signal processing unit 208 is configured to generate a BCCH signal that is broadcast information, to perform a transmission process such as a channel coding process and an inverse fast fourier transform process on the generated signal, and to transfer the signal to the transmission and reception unit 206.

It is noted that as described above, the BCCH signal includes a signal mapped to a BCH as a transport channel and a signal mapped to a P-BCH as a physical channel; and a signal mapped to a DL-SCH as a transport channel and a signal mapped to a PDSCH as a physical channel.

The baseband signal output from the baseband signal processing unit 208 is subjected to a frequency conversion process by the transmission and reception unit 206 and converted to a radio frequency signal, then, amplified by the amplifier unit 204, and transmitted from the transmission and reception antenna 202.

On the other hand, in the data transmitted from the user apparatus 100ₙ to the base station apparatus 200 by way of the uplink, the radio frequency signal received by the transmission and reception antenna 202 is amplified by the amplifier unit 204, subjected to a frequency conversion in the transmission and reception unit 206 to be converted to the baseband signal, and input to the baseband signal processing unit 208.

In the baseband signal processing unit 208, the user data included in the input baseband signal is subjected to an FFT process, an IDFT process, an error correction decoding process, a reception signal of MAC retransmission control, an RLC-layer reception process, a PDCP-layer reception process, etc., and is transferred to the access gateway apparatus 300 via the transmission path interface 212.

The call processing unit 210 is configured to perform a call process such as setting and releasing of a communication channel, a state management of the radio base station 200, and management of the radio resource.

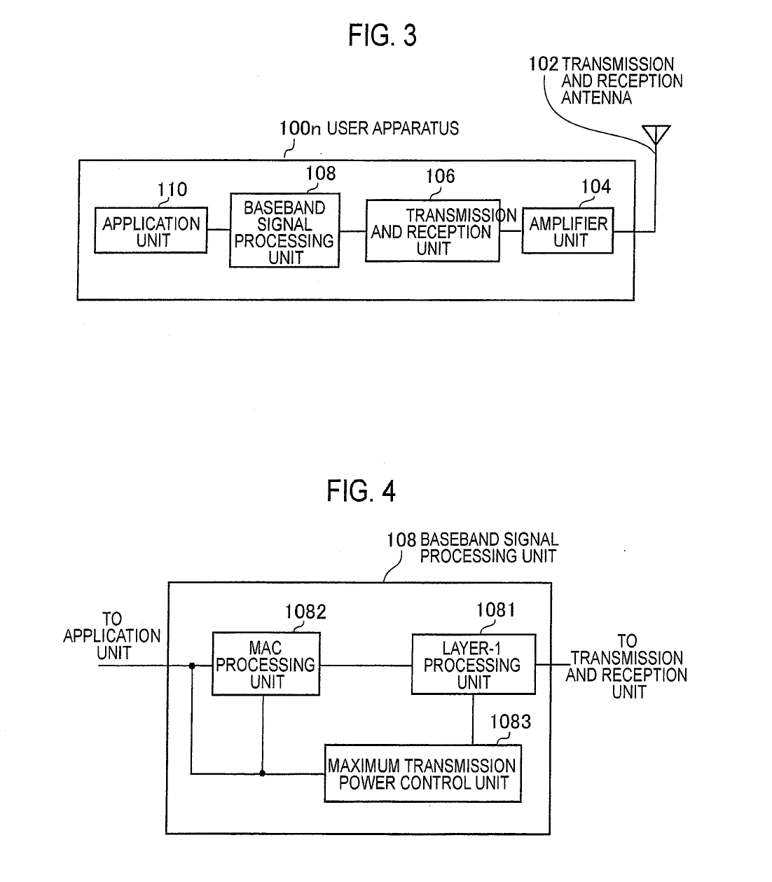

With reference to FIG. 3, the user apparatus 100ₙ according to this embodiment will be explained. As illustrated in FIG. 3, the user apparatus 100ₙ includes a transmission and reception antenna 102, an amplifier unit 104, a transmission and reception unit 106, a baseband signal processing unit 108, and an application unit 110.

In the downlink data, a radio frequency signal received by the transmission and reception antenna 102 is amplified by the amplifier unit 104, and subjected to a frequency conversion in the transmission and reception unit 106 to be converted to a baseband signal.

Such a baseband signal is subjected to an FFT process, an error correction decoding process, a reception process of retransmission control, etc., in the baseband signal processing unit 108. The user data of the downlink in such downlink data is transferred to the application unit 110 in which the transferred data is subjected to a process relating to a physical layer and a layer higher than the MAC layer. The broadcast information in such downlink data is also transferred to the application unit 110.

Further, when the control signal designating the frequency band is received as one portion of the BCCH signal that is broadcast information, the control signal designating such a frequency band is transferred to a maximum transmission power control unit 1083, described later, via the application unit 110. It is noted that the control signal designating such a frequency band may be transferred to the maximum transmission power control unit 1083 without undergoing the application unit 110.

Moreover, the control signal designating such a frequency band may be, for example, the “frequencyBandIndicator” that is one portion of an information element of the “SIB1” that is one of the BCCH signals, as described above.

Further, when the control signal designating the frequency band is received as one portion of the RRC message, the control signal designating such a frequency band is transferred to the maximum transmission power control unit 1083, described later, via the application unit 110. It is noted that the control signal designating such a frequency band may be transferred to the maximum transmission power control unit 1083 without undergoing the application unit 110.

On the other hand, the uplink user data is input to the baseband signal processing unit 108 from the application unit 110, and in the baseband signal processing unit 108, the input data is subjected to a transmission process of retransmission control, a channel coding process, a DFT process, an IFFT process, etc., and transferred to the transmission and reception unit 106.

The baseband signal output from the baseband signal processing unit 108 is then subjected to a frequency conversion process by the transmission and reception unit 106 and converted to a radio frequency band, then, amplified by the amplifier unit 104, and transmitted from the transmission and reception antenna 102.

Such uplink user data is mapped to a PUSCH that is a physical channel. That is, the PUSCH to which such uplink user data is mapped is transmitted to the base station apparatus 200 via the baseband signal processing unit 108, the transmission and reception unit 106, the amplifier unit 104, and the transmission and reception antenna 102, as described above.

It is noted that as described later, in the uplink, in addition to the above-described PUSCH signal, a PUCCH signal, an SRS (Sounding Reference Signal), a physical random access channel (PRACH) signal may also be transmitted to the base station apparatus 200 via the baseband signal processing unit 108, the transmission and reception unit 106, the amplifier unit 104, and the transmission and reception antenna 102, as described above.

With reference to FIG. 4, the configuration of the baseband signal processing unit 108 will be explained.

The baseband signal processing unit 108 includes a layer-1 processing unit 1081, an MAC (Medium Access Control) processing unit 1082, and the maximum transmission power control unit 1083.

The layer-1 processing unit 1081, the MAC (Medium Access Control) processing unit 1082, and the maximum transmission power control unit 1083 are connected to one another. Further, the maximum transmission power control unit 1083 and application unit 110 are connected to each other.

The layer-1 processing unit 1081 is configured to perform an FFT process, a channel decoding process, etc., on the signal received in the downlink.

The layer-1 processing unit 1081 is configured to perform a process of demodulating and decoding the broadcast information included in the signal received in the downlink, and to transmit the decoding result to the MAC processing unit 1082 and the maximum transmission power control unit 1083.

For example, the layer-1 processing unit 1081 is configured to transmit the control signal designating the frequency band included in the broadcast information that is the decoding result of the broadcast channel, to the maximum transmission power control unit 1083.

It is noted that the control signal designating such a frequency band may be transmitted to the maximum transmission power control unit 1083 after firstly being forwarded to the application unit 110. Further, such broadcast information, i.e., the broadcast information including the control signal designating the frequency band, is mapped to the BCCH as the logical channel, for example.

As described above, the BCCH includes that mapped to a BCH as a transport channel and that mapped to a P-BCH as a physical channel; and that mapped to a DL-SCH as a transport channel and that mapped to a PDSCH as a physical channel.

The layer-1 processing unit 1081 is configured to receive information relating to the maximum transmission power from the maximum transmission power control unit 1083, and to use the information relating to the maximum transmission power so as to control transmission power of a PUSCH, a PUCCH, and an SRS (Sounding Reference Signal) or a PRACH (Physical Random Access Channel) of the uplink.

The transmission power control in the layer-1 processing unit 1081 will be explained in more detail.

The layer-1 processing unit 1081 is configured to receive the user data from the MAC processing unit 1082, when transmitting the user data (mapped to PUSCH as a physical channel) in the uplink of the sub-frame.

The layer-1 processing unit 1081 is configured to perform a coding process, a data modulation process, a DFT process, a sub-carrier mapping process, an IFFT process, etc., on the received user data, and transmit the result, as a baseband signal, to the transmission and reception unit 106.

In this case, the uplink shared channel, i.e., the transmission power in a PUSCH, may be determined as follows, for example.

The layer-1 processing unit 1081 is configured to determine transmission power P_{PUSCH} (i) in the PUSCH, based on a maximum transmission power P_{max,} a resource block number M_{PUSCH}(i) for the PUSCH in a sub-frame i, a parameter Po_PUSCH(i), a parameter α, a pathloss (PL) between the radio base station 200 and the user apparatus 100ₙ that are connection destinations of the PUSCH, an offset value Δ_{TF} corresponding to the “Modulation and Coding Scheme (MCS)”, and transmission power control information f (i) relating to the sub-frame i received from the radio base station 200.

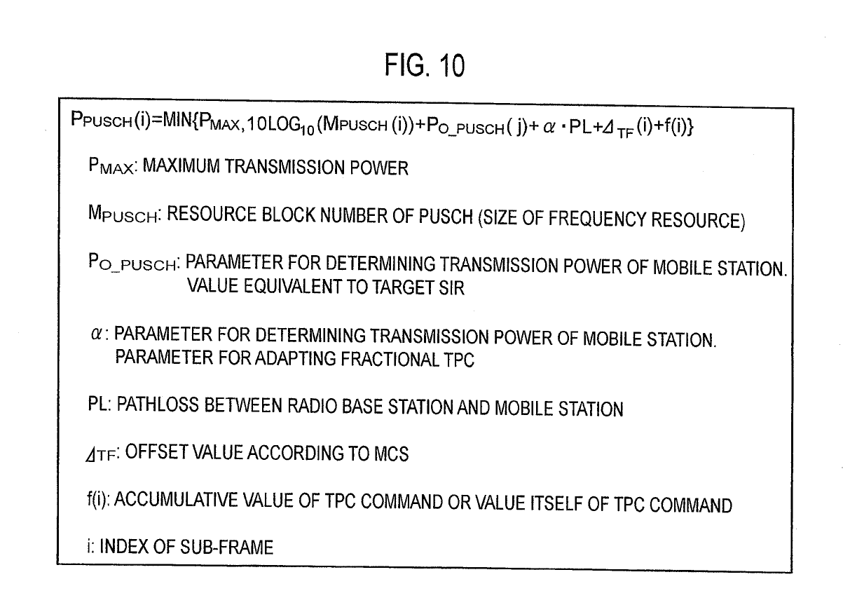

For example, the layer-1 processing unit 1081 is configured to determine the transmission power P_{PUSCH}(i) in the PUSCH according to equation indicated in FIG. 10.

Herein, the layer-1 processing unit 1081 is configured to control the transmission power P_{PUSCH}(i) in the PUSCH according to the equation indicated in FIG. 10, based on the information relating to the maximum transmission power received from the maximum transmission power control unit 1083.

That is, according to the equation indicated in FIG. 10, the layer-1 processing unit 1081 s configured to set the transmission power P_{PUSCH}(i) in the PUSCH, to equal to or less than the maximum transmission power Pₘₐₓ set based on the information relating to the above-described maximum transmission power.

More specifically, according to the equation indicated in FIG. 10, the layer-1 processing unit 1081 s configured to set the transmission power P_{PUSCH}(i) in the PUSCH to a value identical to that of the maximum transmission power Pₘₐₓ set by the information relating to the above-described maximum transmission power, when the determined transmission power P_{PUSCH}(i) in the PUSCH is larger than the maximum transmission power Pₘₐₓ set based on the information relating to the above-described maximum transmission power.

It is noted that as described later, the maximum transmission power Pₘₐₓ notified from the maximum transmission power control unit 1083 may be set based on a control signal designating the frequency band included in the broadcast information (frequency indicator), an amount of frequency resource (specifically, the number of resource blocks or the size of a resource unit), a modulation scheme or a location of the frequency band used in the PUSCH, for example.

It is noted that a “DM RS (Demodulation Reference Signal)” that is a reference signal for decoding is multiplexed on the above-described PUSCH. In this case, the same value may be set to the transmission power of the PUSCH and the transmission power of the DM RS. That is, the process for determining the transmission power of the PUSCH may be applied to that of the DM RS, based on the above-described maximum transmission power Pₘₐₓ.

Further, the layer-1 processing unit 1081 is configured to perform a coding process, a data modulation process, a DFT process, a sub-carrier mapping process, an IFFT process, etc., on a control signal (for example, CQI or Acknowledgement Information), when transmitting the control signal (mapped to PUCCH as a physical channel) such as Acknowledgement Information to CQI or PUSCH in each sub-frame in the uplink, and to transmit the result, as a baseband signal, to the transmission and reception unit 106.

In this case, the layer-1 processing unit 1081 is configured to determine a transmission power P_{PUCCH}(i) in a PUCCH, based on a maximum transmission power Pₘₐₓ a parameter P₀_{_{—}}_{PUCCH} a pathloss PL between the radio base station 200 and the user apparatus 100ₙ that are connection destinations of the PUCCH, an offset value Δ_{TF} corresponding to a transmission format of the PUCCH, and transmission power control information g(i) according to a sub-frame i received from the radio base station 200.

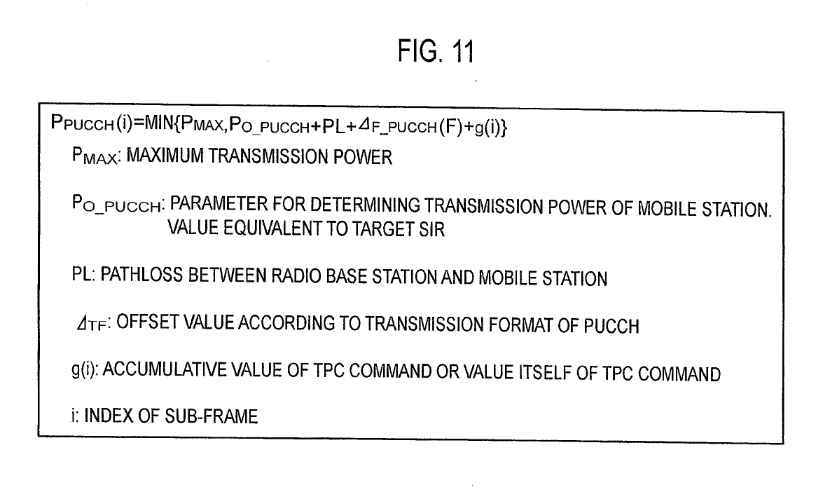

For example, the layer-1 processing unit 1081 is configured to determine the transmission power P_{PUCCH}(i) in the PUCCH according to equation indicated in FIG. 11.

Herein, the layer-1 processing unit 1081 is configured to control the transmission power P_{PUCCH}(i) in the PUCCH according to the equation indicated in FIG. 11, based on the information relating to the maximum transmission power received from the maximum transmission power control unit 1083.

That is, according to the equation indicated in FIG. 11, the layer-1 processing unit 1081 is configured to set the transmission power P_{PUCCH}(i) in the PUCCH, to equal to or less than the maximum transmission power value Pₘₐₓ set based on the information relating to the above-described maximum transmission power.

More specifically, according to the equation indicated in FIG. 11, the layer-1 processing unit 1081 is configured to set the transmission power P_{PUCCH}(i) in the PUCCH to a value identical to that of the maximum transmission power Pₘₐₓ set by the information relating to the above-described maximum transmission power, when the determined transmission power P_{PUCCH}(i) in the PUCCH is larger than the maximum transmission power Pₘₐₓ set based on the information relating to the above-described maximum transmission power.

It is noted that as described later, the maximum transmission power Pₘₐₓ notified from the maximum transmission power control unit 1083 may be set based on a control signal designating the frequency band included in the broadcast information (frequency indicator), an amount of frequency resource (specifically, the number of resource blocks or the size of a resource unit), a modulation scheme, or a location of the frequency band used in the PUSCH, for example.

Further, the layer-1 processing unit 1081 is configured to perform a coding process, a data modulation process, a DFT process, a sub-carrier mapping process, an IFFT process, etc., on SRS when transmitting the SRS in each sub-frame in the uplink, and to transmit the result, as a baseband signal, to the transmission and reception unit 106.

In this case, the layer-1 processing unit 1081 is configured to determine a transmission power P_{SRS} (i) in the uplink SRS channel, based on a maximum transmission power Pₘₐₓ a power offset P_{SRS}_{_{—}}_{OFFSET} between the uplink SRS channel and a PUSCH, a resource block number M_{SRS} used in the uplink SRS channel, a parameter P₀_{_{—}}_{PUSCH}, a parameter α, a pathloss PL between the radio base station 200 and the user apparatus 100ₙ that are connection destinations of the uplink SRS channel, and transmission power control information f (i) according to a sub-frame i received from the radio base station 200.

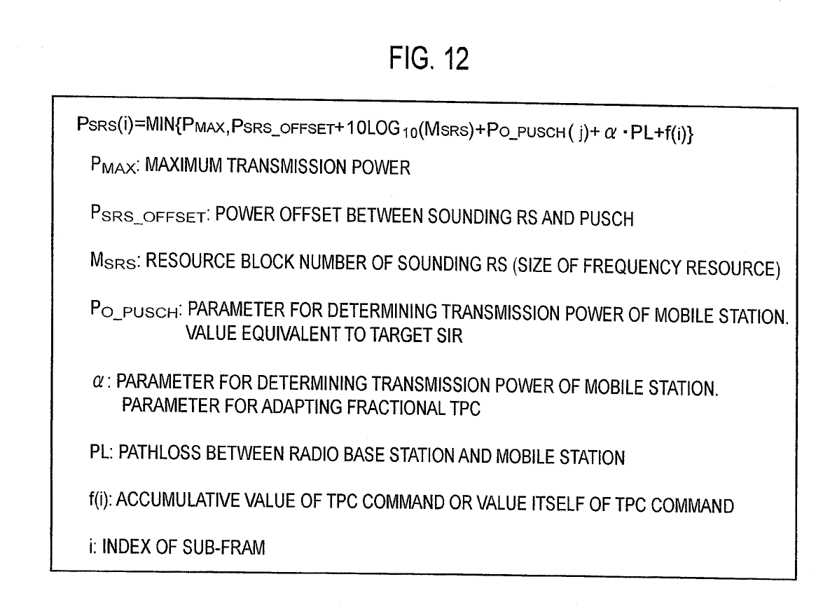

For example, the layer-1 processing unit 1081 is configured to determine the transmission power P_{SRS}) in the uplink SRS channel according to equation indicated in FIG. 12.

Herein, the layer-1 processing unit 1081 is configured to control the transmission power P_{SRS}(i) in the uplink SRS channel according to the equation indicated in FIG. 12, based on the information relating to the maximum transmission power received from the maximum transmission power control unit 1083.

That is, according to the equation indicated in FIG. 12, the layer-1 processing unit 1081 is configured to set the transmission power P_{SRS}(i) in the uplink SRS channel, to equal to or less than the maximum transmission power Pₘₐₓ set based on the information relating to the above-described maximum transmission power.

More specifically, the layer-1 processing unit 1081 is configured to set the transmission power P_{SRS}(i) in the uplink SRS channel to a value identical to that of the maximum transmission power Pₘₐₓ set based on the information relating to the above-described maximum transmission power, when the transmission power P_{SRS}(i) in the uplink SRS channel determined according to the equation indicated in FIG. 12 is larger than the maximum transmission power Pₘₐₓ set by the information relating to the above-described maximum transmission power.

It is noted that as described later, the maximum transmission power Pₘₐₓ notified from the maximum transmission power control unit 1083 may be set based on a control signal designating the frequency band included in the broadcast information (frequency indicator), an amount of frequency resource (specifically, the number of resource blocks or the size of a resource unit), a modulation scheme, or a location of the frequency band used in the uplink SRS channel, for example.

Further, the layer-1 processing unit 1081 is configured to perform a coding process, a data modulation process, a DFT process, a sub-carrier mapping process, an IFFT process, etc., on a PRACH signal, when transmitting the PRACH signal (Random Access Preamble) in each sub-frame in the uplink, and to transmit the result, as a baseband signal, to the transmission and reception unit 106.

In this case, the layer-1 processing unit 1081 is configured to determine a transmission power P_{prach} in a PRACH, based on a maximum transmission power Pₘₐₓ, a power offset Δ_preamble corresponding to a preamble format, a pathloss PL between the radio base station 200 and the user apparatus 100ₙ that are connection destinations of the PRACH, a parameter P₀_{_{—}}ₚᵣₑ, an offset for power lamping dP_rampup, and the number of transmissions of preamble N_pre.

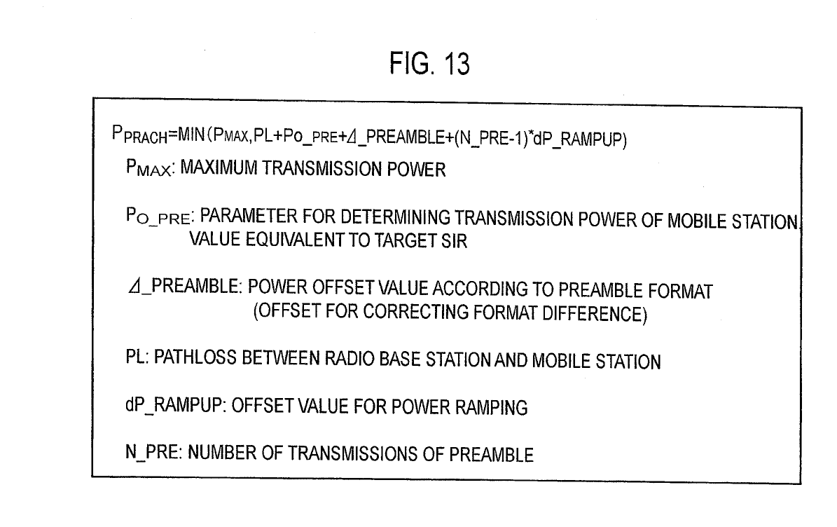

For example, the layer-1 processing unit 1081 is configured to determine the transmission power P_{prach} in the PRACH according to equation indicated in FIG. 13.

Herein, the layer-1 processing unit 1081 is configured to control the transmission power P_{prach} in the PRACH according to the equation indicated in FIG. 13, based on the information relating to the maximum transmission power received from the maximum transmission power control unit 1083.

That is, according to the equation indicated in FIG. 13, the layer-1 processing unit 1081 is configured to set the transmission power P_{prach} in the PRACH, to equal to or less than the maximum transmission power value Pₘₐₓ set based on the information relating to the above-described maximum transmission power.

More specifically, the layer-1 processing unit 1081 is configured to set the transmission power P_{prach} in the PRACH to a value identical to that of the maximum transmission power Pₘₐₓ set by the information relating to the above-described maximum transmission power, when the transmission power P_{prach} in the PRACH determined according to the equation indicated in FIG. 13 is larger than the maximum transmission power Pₘₐₓ set based on the information relating to the above-described maximum transmission power.

It is noted that, as described later, the maximum transmission power Pₘₐₓ notified from the maximum transmission power control unit 1083 may be set based on a control signal designating the frequency band included in the broadcast information (frequency indicator), an amount of frequency resource (specifically, the number of resource blocks or the size of a resource unit), a modulation scheme, or a location of the frequency band used in the PRACH, for example. In this case, the location of the frequency band may be a location of the frequency resource, i.e., a location of the resource block or the resource unit.

Further, methods of calculating the transmission power in a predetermined channel of the uplink such as PUSCH, PUCCH, uplink SRS, and PRACH in the above-described layer-1 processing unit 1081 (equations indicated in FIG. 10 to FIG. 13) are examples, and the transmission power in a predetermined channel of the uplink such as PUSCH, PUCCH, uplink SRS, and PRACH may be determined by a method other than those described above.

In either case, in the user apparatus 100ₙ according to this embodiment, the transmission power in a predetermined channel of the uplink such as PUSCH, PUCCH, uplink SRS, and PRACH is set to equal to or less than the maximum transmission power value Pₘₐₓ set by the information relating to the above-described maximum transmission power.

Further, the layer-1 processing unit 1081 is configured to perform a demodulation-and-decoding process on a PDCCH that is a downlink control channel included in a downlink reception signal, and to transmit the decoded (or decoding) result to the MAC processing unit 1082.

The layer-1 processing unit 1081 is configured to measure a reception signal quality of a DL-RS (Downlink Reference Signal).

Such a reception signal quality may be expressed by a desired signal power-to-undesired signal power ratio, or by an SIR (Signal-to-Interference Ratio).

For example, in calculating CQI, a numerical value range expressing SIR may be divided in a predetermined number of zones, and in this state, the CQI may be derived according to a measurement value of SIR belonging to a particular zone. The CQI is prepared in tune with a predetermined notification cycle, and the CQI is transmitted by a sub-frame corresponding to the cycle.

The layer-1 processing unit 1081 is configured to receive the Acknowledgement Information from an Acknowledgement-Information generation unit 1084 when transmitting the Acknowledgement Information in the sub-frame, and to receives the user data from the MAC processing unit 1082 when transmitting the user data in the sub-frame.

The MAC processing unit 1082 is configured to determine the transmission format of the user data of the uplink, and to perform a transmission process such as retransmission control in the MAC layer, based on a decoded (or decoding) result of the uplink scheduling grant included in the PDCCH received from the layer-1 processing unit 1081.

That is, the MAC processing unit 1082 is configured to determine the transmission format, and to perform the retransmission control, for example, regarding the user data to be transmitted, and to apply the user data to the layer-1 processing unit 1081, when it is granted to perform a communication using the shared channel in the uplink, in the physical downlink control channel received from the layer-1 processing unit 1081.

In this case, in the uplink scheduling grant, the information relating to the transmission power of the uplink shared channel may be included. In this case, also the information relating to the transmission power of the uplink shared channel is applied to the layer-1 processing unit 1081.

Further, the MAC processing unit 1082 is configured to notify the maximum transmission power control unit 1083 of the information relating to the amount of frequency resource, the modulation scheme, and the location of a frequency resource used in the sub-frame included in the uplink scheduling grant.

Further, the MAC processing unit 1082 is configured to perform various processes such as a reception process of the MAC retransmission control of the user data of the downlink, based on the decoding result of the PDCCH received from the layer-1 processing unit 1081.

That is, the MAC processing unit 1082 is configured to decode the received user data, and to perform a CRC check as to whether or not the signal of the user data is erroneous, when it is notified that the communication is performed using the shared channel in the downlink.

Then, the MAC processing unit 1082 is configured to generate the Acknowledgement Information based on the result of such a CRC check, and to notify the layer-1 processing unit 1081 of the Acknowledgement Information.

The MAC processing unit 1082 is configured to generate an acknowledgement signal ACK as the Acknowledgement Information when the result of the CRC check is OK, and to generate a non-acknowledgement signal NACK as the Acknowledgement Information when the result of the CRC check is NG.

The maximum transmission power control unit 1083 is configured to receive the control signal designating the frequency band included in the broadcast information (frequency indicator) from the layer-1 processing unit 1081.

Further, the maximum transmission power control unit 1083 is configured to receive the information relating to the amount of frequency resource, the modulation scheme, and the location of the frequency resource used when transmitting the uplink in the sub-frame from the MAC processing unit 1082.

The maximum transmission power control unit 1083 is configured to determine whether or not to reduce the maximum transmission power in a predetermined channel (PUCCH, PUSCH, uplink-SRS channel, or PRACH) from a rated power regulated in the mobile communication system, based on the frequency band designated by the received control signal.

Specifically, based on at least one of whether or not the frequency band designated by the received control signal is a predetermined frequency band, the amount of frequency resource (specifically, the number of resource blocks or the size of the resource unit), and the modulation scheme used in the above-described predetermined channel, and, the maximum transmission power may be determined.

For example, the maximum transmission power control unit 1083 may be configured that the maximum transmission power in a predetermined channel is not decreased from the above-described rated power (for example, 23 dBm), when the above-described control signal does not designate the predetermined frequency band (for example, when the above-described control signal does not designate “E-UTRA Band”=“18”, more specifically, when the above-described control signal designates “E-UTRA Band”=“1”, for example).

In this case, the “E-UTRA Band 1” is an international frequency band and the “Network Signalling” is needed while the “E-UTRA Band 18” is a frequency band used only in Japan and the “Network Signalling” is not needed (the “frequencyBandIndicator” alone may suffice).

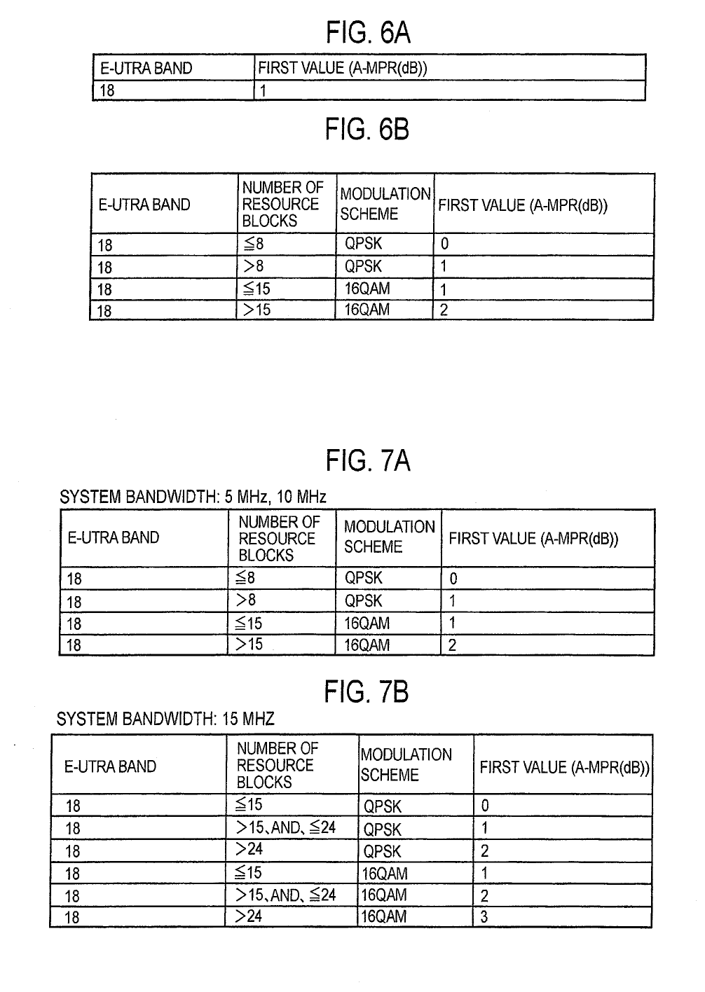

On the other hand, the maximum transmission power control unit 1083 maybe configured to refer to tables illustrated in FIG. 6 to FIG. 8 so as to decrease the maximum transmission power in a predetermined channel by a first value (A-MPR(dB)) from the above-described rated power, when the above-described control signal designates a predetermined frequency band (for example, when the above-described control signal designates “E-UTRA Band”=“18”).

For example, the maximum transmission power control unit 1083 may be configured to set the maximum transmission power in a predetermined channel to “22 dBm”, because the value of the A-MPR is “1 dB”, when the above-described control signal designates a predetermined frequency band (for example, when the above-described control signal designates “E-UTRA Band”=“18”) (see FIG. 6(a)).

Alternately, the maximum transmission power control unit 1083 may be configured to decrease the maximum transmission power in a predetermined channel by the first value (A-MPR (dB)) corresponding to a combination between the number of resource blocks and the modulation scheme used in a predetermined channel, from the above-described rated power, when the above-described control signal designates a predetermined frequency band (for example, when the above-described control signal designates “E-UTRA Band”=“18”) (see FIG. 6(b)).

In this case, the number of resource blocks is a value corresponding to the above-described amount of frequency resource, and may be a frequency bandwidth. Alternately, instead of the above-described number of resource blocks, the size of the resource unit may be used.

For example, the maximum transmission power control unit 1083 may be configured to set the maximum transmission power in a predetermined channel to “23 dBm”, because the value of the A-MPR is “0 dB” when the above-described control signal designates “E-UTRA Band”=“18”, the “number of resource blocks”=“5”, and the “modulation scheme”=“QPSK”, and may set the maximum transmission power in a predetermined channel to “21 dBm”, because the value of the A-MPR is “2 dB” when the above-described control signal designates “E-UTRA Band”=“18”, the “number of resource blocks”=“20”, and the “modulation scheme”=“16 QAM”.

It is noted that in the above-described example, the value of the A-MPR is determined based on the number of resource blocks and the modulation scheme in FIG. 6(b); however, instead thereof, the value of the A-MPR may be determined based on at least one of the number of resource blocks and the modulation scheme.

Alternately, the maximum transmission power control unit 1083 may be configured to decrease the maximum transmission power in a predetermined channel by the first value (A-MPR(dB)) corresponding to the system bandwidth, the number of resource blocks and the modulation scheme used in a predetermined channel, from the above-described rated power, when the above-described control signal designates a predetermined frequency band (for example, when the above-described control signal designates “E-UTRA Band”=“18”) (see FIG. 7).

In this case, the number of resource blocks is a value corresponding to the above-described amount of frequency resource, and may be a frequency bandwidth. Alternately, instead of the above-described number of resource blocks, the size of the resource unit may be used.

Further, the above-described system bandwidth may be referred to as “Channel Bandwidth”, and corresponds to a bandwidth of the entire system.

For example, the maximum transmission power control unit 1083 may be configured to set the maximum transmission power in a predetermined channel to “23 dBm”, because the value of the A-MPR is “0 dB” when the above-described control signal designates

“E-UTRA Band”=“18”, the system bandwidth is “5 MHz”, the “number of resource blocks”=“5”, and the “modulation scheme”=“QPSK”, and may be configured to set the maximum transmission power in a predetermined channel to “20 dBm”, because the value of the A-MPR is 3 dB when the above-described control signal designates “E-UTRA Band”=“18”, the system bandwidth is “15 MHz”, the “number of resource blocks”=“30”, and the “modulation scheme”=“16 QAM”.

It is noted that in the above-described example, the value of the A-MPR is determined based on the system bandwidth, the number of resource blocks, and the modulation scheme in FIG. 7; however, instead thereof, the value of the A-MPR may be determined based on at least one of the system bandwidth, the number of resource blocks, and the modulation scheme.

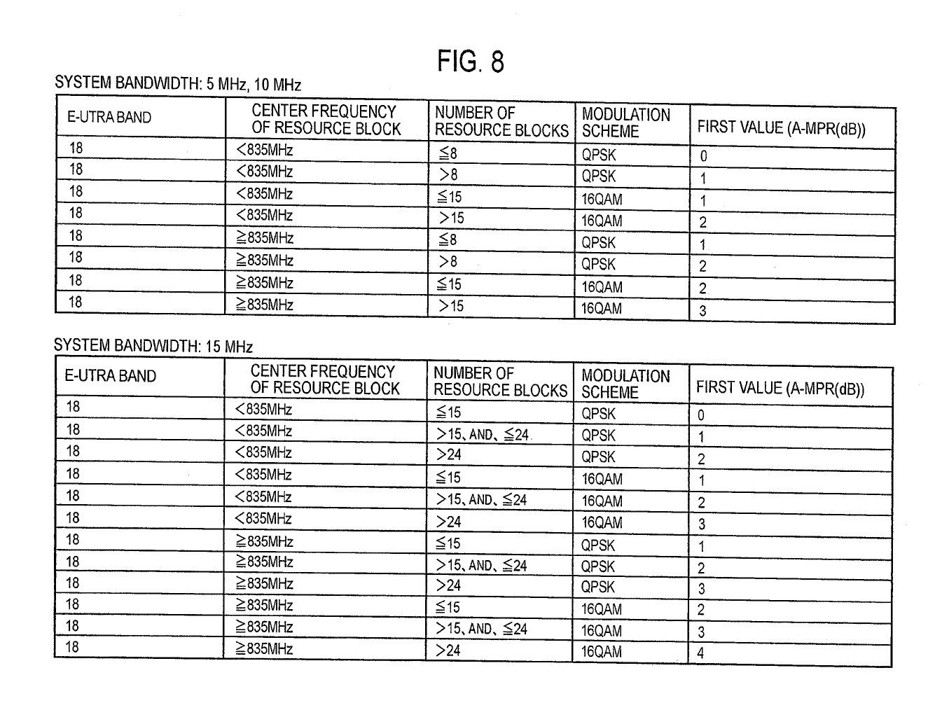

Alternately, the maximum transmission power control unit 1083 may be configured to decrease the maximum transmission power in a predetermined channel by the first value (A-MPR (dB)) corresponding to the system bandwidth, the number of resource blocks, the modulation scheme and the location of a frequency resource used in a predetermined channel, from the above-described rated power, when the above-described control signal designates a predetermined frequency band (for example, when the above-described control signal designates “E-UTRA Band”=“18”) (see FIG. 8).

In this case, the above-described location of a frequency is a value corresponding to a location of a frequency resource used when transmitting the uplink, and may be a location of the resource block or a location of the resource unit.

Further, the location of the resource block may be determined by the resource block number, a center frequency of the resource block, or a center frequency of the frequency resource, alternately, may be determined by the resource block number with the smallest frequency.

In this case, the center frequency of the resource block may be a center frequency of a resource block group configured by a plurality of resource blocks, when the plurality of resource blocks are present.

Alternately, as information relating to the location of the frequency resource, a value other than the resource block number or the center frequency may be used.

For example, in the below description, a frequency band of the uplink of “E-UTRA Band”=“18” is set to from 830 MHz to 845 MHz.

For example, the maximum transmission power control unit 1083 may be configured to set the maximum transmission power in a predetermined channel to “23 dBm”, because the value of the A-MPR is “0 dB” when the above-described control signal designates “E-UTRA Band”=“18”, the system bandwidth is “5 MHz”, the center frequency of the frequency resource to be transmitted (group of resource blocks) is “832 MHz”, the “number of resource blocks”=“5”, and the “modulation scheme”=“QPSK”, and may be configured to set the maximum transmission power in a predetermined channel to “19 dBm”, because the value of the A-MPR is “4 dB” when the above-described control signal designates “E-UTRA Band”=“18”, the system bandwidth is “15 MHz”, the center frequency of the frequency resource to be transmitted (group of resource blocks) is “840 MHz”, the “number of resource blocks”=“30”, and the “modulation scheme”=“16 QAM”.

It is noted that in the above-described example, the value of the A-MPR is determined based on the system bandwidth, the location of a frequency resource, the number of resource blocks, and the modulation scheme in FIG. 8; however, instead thereof, the value of the A-MPR may be determined based on at least one of the system bandwidth, the location of a frequency resource, the number of resource blocks, and the modulation scheme.

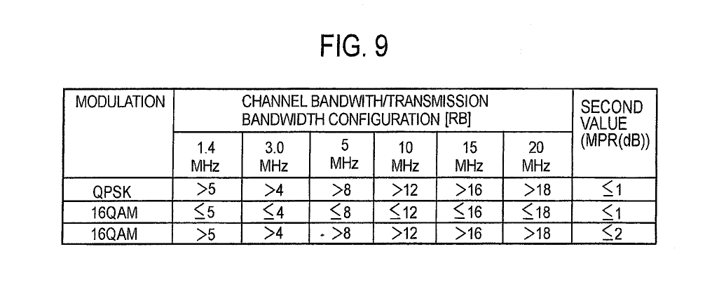

Further, the maximum transmission power control unit 1083 may be configured to refer to a table illustrated in FIG. 9, so as to decrease the maximum transmission power in a predetermined channel by a second value (MPR (dB)) corresponding to a combination between the modulation scheme and the resource block number (resource block amount) used in a predetermined channel, from the above-described rated power (for example, “23 dBm”), when the above-described control signal does not designate a predetermined frequency band (for example, when the above-described control signal does not designate “E-UTRA Band”=“18”, more specifically, when the above-described control signal designates “E-UTRA Band” “1”.

For example, the maximum transmission power control unit 1083 may be configured to set the maximum transmission power in a predetermined channel to “21 dBm”, because the value of the MPR (second value) is “2 dB” when the above-described control signal designates “E-UTRA Band”=“1”, the system bandwidth (Channel Bandwidth) is “10 MHz”, the modulation method is “16 QAM”, and the frequency resource amount (resource block number) is “20 Resource Blocks (RBs)”. In this case, “1 Resource Block” maybe “180 kHz”.

For example, the maximum transmission power control unit 1083 may be configured to set the maximum transmission power in a predetermined channel to “23 dBm”, because the value of the MPR is “0 dB” when the above-described control signal designates “E-UTRA Band”=“1”, the system. bandwidth (Channel Bandwidth) is “10 MHz”, the modulation method is “QPSK”, and the frequency resource amount (resource block number) is “2 Resource Blocks (RBs)”.

On the other hand, the maximum transmission power control unit 1083 maybe configured to refer to tables illustrated in FIG. 6 to FIG. 9, when the above-described control signal designates a predetermined frequency band, so as to decrease the maximum transmission power in a predetermined channel, by the first value (A-MPR(dB)) and the second value (MPR(dB)) corresponding to a combination between the modulation scheme and the resource block number (resource block amount) used in a predetermined channel, from the above-described rated power. In this case, as described in the following example, a final reduction amount of maximum transmission power may be determined by addition of the MPR to the A-MPR.

For example, the maximum transmission power control unit 1083 may be configured to set the maximum transmission power in a predetermined channel to “20 dBm”, because the value of the MPR (second value) is “2 dB” and the value of the A-MPR (first value) is “1 dB” when the above-described control signal designates “E-UTRA Band”=“18”, the system bandwidth (Channel Bandwidth) is “10 MHz”, the modulation scheme is “16 QAM”, and the frequency resource amount (resource block number) is “20 Resource Blocks (RBs)” (see FIG. 6(a) and FIG. 9).

For example, the maximum transmission power control unit 1083 may be configured to set the maximum transmission power in a predetermined channel to “22 dBm”, because the value of the MPR (second value) is “0 dB” and the value of the A-MPR (first value) is “1 dB” when the above-described control signal designates “E-UTRA Band”=“18”, the system bandwidth (Channel Bandwidth) is “10 MHz”, the modulation scheme is “QPSK”, and the frequency resource amount (resource block number) is “2 Resource Blocks (RBs)” (see FIG. 6(a) and FIG. 9).

Alternately, when the above-described control signal designates a predetermined frequency band (for example, the control signal designates “E-UTRA Band”=“18”), the maximum transmission power control unit 1083 may be configured to set to decrease the maximum transmission power in a predetermined channel, by the first value (A-MPR(dB)) corresponding to a combination between the number of resource blocks and the modulation scheme used in a predetermined channel, and the second value (MPR(dB)) corresponding to a combination between the modulation scheme and the resource block number (resource block amount) used in a predetermined channel, from the above-described rated power (see FIG. 6(b) and FIG. 9).

For example, the maximum transmission power control unit 1083 may be configured to set the maximum transmission power in a predetermined channel to “19 dBm”, because the value of the MPR (second value) is “2 dB” and the value of the A-MPR (first value) is “2 dB” when the above-described control signal designates “E-UTRA Band”=“18”, the system bandwidth (Channel Bandwidth) is “10 MHz”, the modulation scheme is “16 QAM”, and the frequency resource amount (resource block number) is “20 Resource Blocks (RBs)” (see FIG. 6(b) and FIG. 9).

For example, the maximum transmission power control unit 1083 may be configured to set the maximum transmission power in a predetermined channel to “23 dBm”, because the value of the MPR (second value) is “0 dB” and the value of the A-MPR (first value) is “0 dB” when the above-described control signal designates “E-UTRA Band”=“18”, the system bandwidth (Channel Bandwidth) is “10 MHz”, the modulation scheme is “QPSK”, and the frequency resource amount (resource block number) is “2 Resource Blocks (RBs)” (see FIG. 6(b) and FIG. 9).

It is noted that in the above-described example, the value of the A-MPR is determined based on the number of resource blocks and the modulation scheme in FIG. 6(b); however, instead thereof, the value of the A-MPR may be determined based on at least one of the number of resource blocks and the modulation scheme.

Alternately, the maximum transmission power control unit 1083 maybe configured to decrease the maximum transmission power in a predetermined channel, by the first value (A-MPR(dB)) corresponding to a combination among the number of resource blocks, the modulation scheme and the system bandwidth used in a predetermined channel, and the second value (MPR(dB)) corresponding to a combination between the modulation scheme and the resource block number (resource block amount) used in a predetermined channel, from the above-described rated power, when the above-described control signal designates a predetermined frequency bandwidth (for example, when the above-described control signal designates “E-UTRA Band”=“18”) (see FIG. 7 and FIG. 9).

For example, the maximum transmission power control unit 1083 may be configured to set the maximum transmission power in a predetermined channel to “18 dBm”, because the value of the MPR (second value) is “2 dB” and the value of the A-MPR (first value) is “3 dB” when the above-described control signal designates “E-UTRA Band”=“18”, the system bandwidth (Channel Bandwidth) is “15 MHz”, the modulation scheme is “16 QAM”, and the frequency resource amount (resource block number) is “40Resource Blocks (RBs)” (see FIG. 7 and FIG. 9).

For example, the maximum transmission power control unit 1083 may be configured to set the maximum transmission power in a predetermined channel to “23 dBm”, because the value of the MPR (second value) is “0 dB” and the value of the A-MPR (first value) is “0 dB” when the above-described control signal designates “E-UTRA Band”=“18”, the system bandwidth (Channel Bandwidth) is “5 MHz”, the modulation scheme is “QPSK”, and the frequency resource amount (resource block number) is “2 Resource Blocks (RBs)” (see FIG. 7 and FIG. 9).

It is noted that in the above-described example, the value of the A-MPR is determined based on the number of resource blocks, the modulation scheme, and the system bandwidth in FIG. 7; however, instead thereof, the value of the A-MPR may be determined based on at least one of the number of resource blocks, the modulation scheme, and the system bandwidth.

Alternately, the maximum transmission power control unit 1083 may be configured to decrease the maximum transmission power in a predetermined channel, by the first value (A-MPR (dB)) corresponding to a combination among the number of resource blocks, the modulation scheme, the system bandwidth, and the location of a frequency resource used in a predetermined channel, and the second value (MPR (dB)) corresponding to a combination between the modulation scheme and the resource block number (resource block amount) used in a predetermined channel, from the above-described rated power, when the above-described control signal designates a predetermined frequency band (for example, when the above-described control signal designates “E-UTRA Band”=“18”) (see FIG. 8 and FIG. 9).

For example, in the below description, a frequency band of the uplink of “E-UTRA Band”=“18” is set to from 830 MHz to 845 MHz.

For example, the maximum transmission power control unit 1083 may be configured to set the maximum transmission power in a predetermined channel to “23 dBm”, because the value of the MPR (second value) is “0 dB” and the value of the A-MPR (first value) is “0 dB” when the above-described control signal designates “E-UTRA Band”=“18”, the system bandwidth (Channel Bandwidth) is “5 MHz”, the center frequency of the frequency resource to be transmitted (group of resource blocks) is “832 MHz”, the “number of resource blocks”=“5”, and the “modulation scheme”=“QPSK” (see FIG. 8 and FIG. 9).

For example, the maximum transmission power control unit 1083 may be configured to set the maximum transmission power in a predetermined channel to “17 dBm”, because the value of the MPR (second value) is “2 dB” and the value of the A-MPR (first value) is “4 dB” when the above-described control signal designates “E-UTRA Band”=“18”, the system bandwidth (Channel Bandwidth) is “15 MHz”, the center frequency of the frequency resource to be transmitted (group of resource blocks) is “840 MHz”, the “number of resource blocks”=“30”, and the “modulation scheme”=“16 QAM” (see FIG. 8 and FIG. 9).

It is noted that in the above-described example, the value of the A-MPR is determined based on the number of resource blocks, the modulation scheme, the system bandwidth, and the location of a frequency resource in FIG. 8; however, instead thereof, the value of the A-MPR may be determined based on at least one of the number of resource blocks, the modulation scheme, the system bandwidth, and the location of a frequency resource.

It is noted that in the above-described example, a final reduction amount of maximum transmission power is calculated according to “reduction amount of maximum transmission power)=(MPR)+(A-MPR)”; however, instead thereof, the reduction amount may be calculated according to “reduction amount of maximum transmission power)=Max (MPR, A-MPR)”.

It is noted that in the above-described example, the amount of the frequency resource or the modulation scheme used in the sub-frame of a PUSCH is included in the uplink scheduling grant mapped to a PDCCH, and the maximum transmission power control unit 1083 is configured to receive such information from the MAC processing unit 1082.

Further, in the above-described tables illustrated in FIG. 6 to FIG. 8, the frequency resource or the modulation scheme may be associated further with a performance regulation of a predetermined Spurious emission, a performance regulation relating to a spectrum mask, a performance regulation relating to an adjacent channel interference, etc.

Specifically, examples of the above-described predetermined performance regulation of the Spurious emission may include the “Spurious emission (“−41 dBm/300 kHz” in a frequency band from 1884.5 to 1919.6 MHz)” to a PHS band, and the “Spurious emission (“−37 dBm/MHz”)” in a frequency band from 860 to 874 MHz. It is noted that the above-described performance regulation of the Spurious emission is regulated by an absolute value of the interference power in a predetermined frequency band.

In this case, the user apparatus 100ₙ may perform a process of setting the maximum transmission power to a small value, based on the reduction amount from the rated power in FIG. 6 to FIG. 9, only when it is not possible to satisfy the above-described predetermined performance regulation of the Spurious emission (or the performance regulation relating to the spectrum mask and the performance regulation relating to the ACLR (Adjacent Carrier Leakage Ratio).

Herein, the above-described performance regulation relating to the spectrum mask and the performance regulation relating to an adjacent channel interference is a regulation relating to a ratio of the interference power in a predetermined adjacent or proximate frequency band to the transmission power within a frequency band of the present system.

That is, the above-described performance regulation relating to the spectrum mask or the performance regulation relating to an adjacent channel interference is regulated by the above-described relative value.

It is noted that the “reduction amount from the rated power” in FIG. 6 to FIG. 9 is a “value obtained when the maximum transmission power may be decreased”, and the user apparatus 100ₙ may perform a process in which the maximum transmission power in a predetermined channel is not decreased, or the reduction amount is made smaller than the “reduction amount from the rated power” in FIG. 6 to FIG. 9, when it is possible to satisfy the above-described predetermined performance regulation of the Spurious emission (or the performance regulation relating to the spectrum mask or the performance regulation relating to the adjacent channel interference).

Further, in the above-described example, the maximum transmission power control unit 1083 is configured to determine the maximum transmission power based on at least one of the control signal designating the frequency band, the amount of frequency resource, the modulation scheme, and the center frequency of the frequency resource; however, instead thereof, the maximum transmission power control unit 1083 may be configured to determine the maximum transmission power based on the control signal designating the frequency band and other metrics.

For example, the maximum transmission power control unit 1083 may be configured to determine the maximum transmission power based on the control signal designating the frequency band and the “Cubic metric”. In this case, the “Cubic metric” is one of the metrics for estimating the interference power to the adjacent channel.

It is noted that in the above-described example, the “E-UTRA Band 18” may be a frequency band defined in a certain region only. More specifically, the “E-UTRA Band 18” may be a frequency band operated in Japan only.

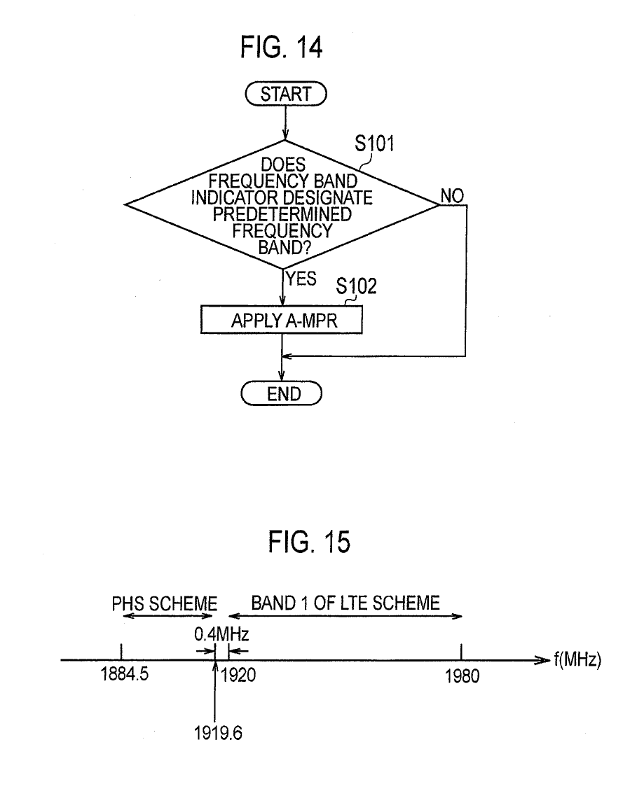

With reference to FIG. 14, the operation of the user apparatus 100ₙ according to this embodiment will be briefly described below.

As illustrated in FIG. 14, in step S101, when the user apparatus 100ₙ receives the control signal designating a frequency band in a predetermined sub-frame, the user apparatus 100ₙ determines whether or not the “frequency indicator” included in the control signal designates a predetermined frequency band (for example, “E-UTRA Band”=“18”).

When it is determined that the “frequency indicator” does not designate the predetermined frequency band (step S101: NO), the user apparatus 100ₙ ends the present operation without performing the “A-MPR (process of reducing the maximum transmission power based on FIG. 6 to FIG. 8)” on a predetermined channel. However, in this case, the user apparatus 100ₙ may perform the “MPR (process of reducing the maximum transmission power based on FIG. 9)” on a predetermined channel.

On the other hand, when it is determined that the “frequency indicator” designates a predetermined frequency band (step S101: YES), the user apparatus 100ₙ performs the “A-MPR (process of reducing the maximum transmission power based on FIG. 6 to FIG. 8)” on the predetermined channel.

In this case, when user apparatus 100ₙ performs the process of reducing the maximum transmission power based on FIG. 6 to FIG. 8, the user apparatus 100ₙ may further perform the “MPR (process of reducing the maximum transmission power based on FIG. 9)” on a predetermined channel.

It is noted that when it is determined that the “frequency indicator” designates a predetermined frequency band (step S101: YES), the user apparatus 100ₙ may always perform the “A-MPR (process of reducing the maximum transmission power based on FIG. 6 to FIG. 8)” on a predetermined channel.

Alternately, when it is determined that the “frequency indicator” designates a predetermined frequency band (step S101: YES), the user apparatus 100ₙ may always perform the “A-MPR (process of reducing the maximum transmission power based on FIG. 6 to FIG. 8)” on a predetermined channel, irrespective of the above-described “Network Signalling value”.

Alternately, when it is determined that the “frequency indicator” designates a predetermined frequency band (step S101: YES), the user apparatus 100ₙ may perform the “A-MPR (process of reducing the maximum transmission power based on FIG. 6 to FIG. 8)” on a predetermined channel, all the time or when another condition is met, not only when the value of the above-described “Network Signalling value” is the “NS_{—}01” but also when the value of the above-described “Network Signalling value” is not notified.

In this case, the “NS_{—}01” of the “Network Signalling value” means that the A-MPR is not applied. That is, when it is determined that the “frequency indicator” designates a predetermined frequency band (step S101: YES), the user apparatus 100ₙ may perform the “A-MPR (process of reducing the maximum transmission power based on FIG. 6 to FIG. 8)” on a predetermined channel all the time or when another condition is met, even when the “Network Signalling value” indicating that the A-MPR is not applied is notified.

Alternately, when it is determined that the “frequency indicator” designates a predetermined frequency band and when the value of the above-described “Network Signalling value” is the “NS_{—}01”, or when the value of the above-described “Network Signalling value” is not notified, the user apparatus 100ₙ may perform the “A-MPR (process of reducing the maximum transmission power based on FIG. 6 to FIG. 8)” on a predetermined channel, when another condition is met.

In this case, the “NS_{—}01” of the “Network Signalling value” means that the A-MPR is not applied. That is, in other words, in this case, the user apparatus 100ₙ may determine as to whether or not the the A-MPR should be applied based only on the “frequency indicator”, i.e., without consideration of the notified “Network Signalling value”.

### (Operation and Effect of the Mobile Communication System According to the First Embodiment of the Present Invention)

According to the mobile communication system based on the first embodiment of the present invention, it is possible to appropriately reduce the amount of interference to the adjacent mobile communication system depending on a region where the mobile communication system is applied or on various other situations, without the use of the redundant information element “Network Signalling value”, as a result of which it is possible to provide a service using an efficient mobile communication.

The above-described aspects of the embodiments may be expressed as follows:

A first aspect of the embodiment is summarized as a user apparatus 100ₙ that performs a radio communication with a base station apparatus 200 within a mobile communication system 1000, including a maximum transmission power control unit 1083 configured to receive a control signal designating a frequency band (frequency indicator) in a downlink, and to control a maximum transmission power in a predetermined channel of an uplink, in which the maximum transmission power control unit 1083 is configured to determine whether or not to decrease the maximum transmission power in a predetermined channel from a rated power regulated in a mobile communication system, according to a frequency band designated by the control signal.

In this case, the frequency band designated by the control signal may be a frequency band “E-UTRA Band” in the E-UTRA system, for example.

In the first aspect of the embodiment, when the above-described control signal does not designate a predetermined frequency band (for example, “E-UTRA Band”=“18”), the maximum transmission power control unit 1083 may be configured not to decrease the maximum transmission power in a predetermined channel from the above-described rated power, and when the above-described control signal designates the predetermined frequency band, the maximum transmission power control unit 1083 may be configured to decrease the maximum transmission power in a predetermined channel by a first value (A-MPR (dB)) from the above-described rated power.

In the first aspect of the embodiment, when the above-described control signal does not designate a predetermined frequency band, the maximum transmission power control unit 1083 may be configured not to decrease the maximum transmission power in a predetermined channel from the above-described rated power, and when the above-described control signal designates the predetermined frequency band, the maximum transmission power control unit 1083 may be configured to decrease the maximum transmission power in a predetermined channel, by a first value (A-MPR (dB)) corresponding to a frequency bandwidth (the number of resource blocks) used in a predetermined channel, from the above-described rated power.

In the first aspect of the embodiment, when the above-described control signal does not designate a predetermined frequency band, the maximum transmission power control unit 1083 may be configured to decrease the maximum transmission power in a predetermined channel, by a second value (MPR (dB)) corresponding to a combination between a modulation scheme and a resource block number used in a predetermined channel, from the above-described rated power, and when the above-described control signal designates the predetermined frequency band, the maximum transmission power control unit 1083 may be configured to decrease the maximum transmission power in a predetermined channel, by the first value (A-MPR (dB)) and the second value (MPR (dB)) corresponding to a combination between the modulation scheme and the resource block number used in a predetermined channel, from the above-described rated power.

In the first aspect of the embodiment, when the above-described control signal does not designate a predetermined frequency band, the maximum transmission power control unit 1083 may be configured to decrease the maximum transmission power in a predetermined channel, by a second value (MPR (dB)) corresponding to a combination between a modulation scheme and a resource block number used in a predetermined channel, from the above-described rated power, and when the above-described control signal designates the predetermined frequency band, the maximum transmission power control unit 1083 may be configured to decrease the maximum transmission power in a predetermined channel, by a first value (A-MPR (dB)) corresponding to at least one of a frequency bandwidth (the number of resource blocks), a modulation scheme, a location of a frequency resource, and a system bandwidth used in a predetermined channel, and a second value (MPR (dB)) corresponding to a combination between the modulation scheme and the resource block number used in a predetermined channel, from the above-described rated power.

In the first aspect of the embodiment, it maybe configured such that the above-described control signal is transmitted by using any one of a broadcast channel, an RRC message at the time of a start of communication, an RRC message in a handover (for example, the “Handover Command” instructing Handover), and an NAS message at the time of location registration.

In the first aspect of the embodiment, the above-described predetermined channel may be any one of an uplink shared channel, an uplink control channel, a sounding reference signal for uplink, a demodulation reference signal for uplink, and an uplink random access channel.

In the first aspect of the embodiment, when the above-described control signal designates a predetermined frequency band, the maximum transmission power control unit 1083 may be configured to decrease the maximum transmission power in a predetermined channel so that an amount of interference to a previously determined frequency band is equal to or less than a predetermined threshold value than the above-described rated power.

In the first aspect of the embodiment, the above-described “amount of interference to the previously determined frequency band being equal to or less than a predetermined threshold value” may indicate that a “relative value of the interference power to a frequency band adjacent to the frequency band used in a predetermined channel for the transmission power in a predetermined channel is equal to or less than the first threshold value”.

In the first aspect of the embodiment, the above-described “amount of interference to the previously determined frequency band being equal to or less than a predetermined threshold value” may indicate that “an absolute value of the amount of interference to the previously determined frequency band is equal to or less than a second threshold value”.

In the first aspect of the embodiment, the maximum transmission power in a predetermined channel may be set individually to each of a plurality of frequency bands.

In the first aspect of the embodiment, the maximum transmission power in a predetermined channel may be set individually to each of a plurality of system bandwidths.

In the first aspect of the embodiment, the maximum transmission power control unit 1083 may be configured to determine whether or not to decrease the maximum transmission power in a predetermined channel from the rated power regulated in a mobile communication system, according to whether or not the above-described frequency band is a frequency band used only in a predetermined region.

A second aspect of the embodiment is sumerized as a mobile communication method in which a radio communication is performed between a base station apparatus and a user apparatus in a mobile communication system, including the steps of: (A) receiving, at the user apparatus, a control signal designating a frequency band in a downlink; and (B) controlling, at the user apparatus, a maximum transmission power in a predetermined channel of an uplink; and in the step (B), the user apparatus determines whether or not to decrease the maximum transmission power in a predetermined channel from a rated power regulated in the mobile communication system, according to the frequency band designated by the control signal.

The operation of the above-described radio base station apparatus 200 and the user apparatus 100ₙ may be implemented by a hardware, may also be implemented by a software module executed by a processor, and may further be implemented by the combination of the both.

The software module may be arranged in a storing medium of an arbitrary format such as RAM (Random Access Memory), a flash memory, ROM (Read Only Memory), EPROM (Erasable Programmable ROM), EEPROM (Electronically Erasable and Programmable ROM), a register, a hard disk, a removable disk, and CD-ROM.

Such a storing medium is connected to the processor so that the processor can write and read information into and from the storing medium. Such a storing medium may also be accumulated in the processor. Such a storing medium and processor may be arranged in ASIC. Such ASIC may be arranged in the radio base station apparatus 200 and the user apparatus 100ₙ. As a discrete component, such a storing medium and processor may be arranged in the radio base station apparatus 200 and the user apparatus 100ₙ.

Thus, the present invention has been explained in detail by using the above-described embodiments; however, it is obvious that for persons skilled in the art, the present invention is not limited to the embodiments explained herein. The present invention can be implemented as a corrected, modified mode without departing from the gist and the scope of the present invention defined by the claims. Therefore, the description of the specification is intended for explaining the example only and does not impose any limited meaning to the present invention.

1. Apparatus that performs a radio communication with a base station apparatus within a mobile communication system, comprising:
a reception unit configured to receive a control signal designating a frequency band in a downlink; and
a maximum transmission power control unit configured to control a maximum transmission power in a predetermined channel of an uplink; wherein
the maximum transmission power control unit is configured to determine whether or not to decrease the maximum transmission power in a predetermined channel from a rated power regulated in the mobile communication system, according to the frequency band designated by the control signal.

2. The user apparatus according to claim 1, wherein
the maximum transmission power control unit is configured not to decrease the maximum transmission power in a predetermined channel from the rated power, when the control signal does not designate a predetermined frequency band; and
the maximum transmission power control unit is configured to decrease the maximum transmission power in a predetermined channel by a first value from the rated power, when the control signal designates the predetermined frequency band.

3. The user apparatus according to claim 1, wherein
the maximum transmission power control unit is configured not to decrease the maximum transmission power in a predetermined channel from the rated power, when the control signal does not designate a predetermined frequency band; and
the maximum transmission power control unit is configured to decrease the maximum transmission power in a predetermined channel, by a first value determined based on at least one of the size of a frequency resource, a modulation scheme and a location of the frequency resource used in the predetermined channel, from the rated power, when the control signal designates the predetermined frequency band.

4. The user apparatus according to claim 1, wherein
the maximum transmission power control unit is configured to decrease the maximum transmission power in a predetermined channel, by a second value corresponding to a combination between a modulation scheme and the size of a frequency resource used in the predetermined channel, from the rated power, when the control signal does not designate a predetermined frequency band; and
the maximum transmission power control unit is configured to decrease the maximum transmission power in a predetermined channel by a first value and a second value corresponding to a combination between a modulation scheme and the size of a frequency resource used in the predetermined channel, from the rated power, when the control signal designates the predetermined frequency band.

5. The user apparatus according to claim 1, wherein
the maximum transmission power control unit is configured to decrease the maximum transmission power in a predetermined channel, by a second value corresponding to a combination between a modulation scheme and the size of a frequency resource used in the predetermined channel, from the rated power, when the control signal does not designate a predetermined frequency band; and
the maximum transmission power control unit is configured to decrease the maximum transmission power in the predetermined channel, by a first value determined based on at least one of a frequency bandwidth, a modulation scheme, a location of a frequency resource and a system bandwidth used in the predetermined channel, and a second value corresponding to a combination between the modulation scheme and the size of the frequency resource used in the predetermined channel, from the rated power, when the control signal designates the predetermined frequency band.

6. The user apparatus according to claim 1, wherein
the control signal is configured to be transmitted by using any one of a broadcast channel, an RRC message at the time of a start of communication, an RRC message in a handover, and an NAS message at the time of location registration.

7. The user apparatus according to claim 1, wherein
the predetermined channel is at least one of an uplink shared channel, an uplink control channel, a sounding reference signal for uplink, a demodulation reference signal for uplink, and an uplink random access channel.

8. The user apparatus according to claim 1, wherein
the maximum transmission power control unit is configured to decrease the maximum transmission power in a predetermined channel from the rated power, so that an amount of interference to a previously determined frequency band is equal to or less than a predetermined threshold value, when the control signal designates a predetermined frequency band.

9. The user apparatus according to claim 8, wherein
that the amount of interference to the previously determined frequency band is equal to or less than the predetermined threshold value indicates that a relative value of the interference power to a frequency band adjacent to the frequency band used in the predetermined channel for the transmission power in the predetermined channel is equal to or less than the first threshold value.

10. The user apparatus according to claim 8, wherein
that the amount of interference amount to the previously determined frequency band is equal to or less than the predetermined threshold value indicates that an absolute value of the amount of interference to the previously determined frequency band is equal to or less than the second threshold value.

11. The user apparatus according to claim 1, wherein
the maximum transmission power control unit is configured to determine whether or not to decrease the maximum transmission power in a predetermined channel from the rated power regulated in the mobile communication system, according to whether or not the frequency band is a frequency band used only in a predetermined region.

12. A mobile communication method in which a radio communication is performed between a base station apparatus and a user apparatus within a mobile communication system, comprising the steps of:
(A) receiving, at the user apparatus, a control signal designating a frequency band in a downlink; and
(B) controlling, at the user apparatus, a maximum transmission power in a predetermined channel of an uplink; and
in the step (B), the user apparatus determines whether or not to decrease the maximum transmission power in a predetermined channel from a rated power regulated in the mobile communication system, according to the frequency band designated by the control signal.

13. The user apparatus according to claim 2, wherein
the control signal is configured to be transmitted by using any one of a broadcast channel, an RRC message at the time of a start of communication, an RRC message in a handover, and an NAS message at the time of location registration.

14. The user apparatus according to claim 3, wherein
the control signal is configured to be transmitted by using any one of a broadcast channel, an RRC message at the time of a start of communication, an RRC message in a handover, and an NAS message at the time of location registration.

15. The user apparatus according to claim 4, wherein
the control signal is configured to be transmitted by using any one of a broadcast channel, an RRC message at the time of a start of communication, an RRC message in a handover, and an NAS message at the time of location registration.

16. The user apparatus according to claim 5, wherein
the control signal is configured to be transmitted by using any one of a broadcast channel, an RRC message at the time of a start of communication, an RRC message in a handover, and an NAS message at the time of location registration.

17. The user apparatus according to claim 2, wherein
the predetermined channel is at least one of an uplink shared channel, an uplink control channel, a sounding reference signal for uplink, a demodulation reference signal for uplink, and an uplink random access channel.

18. The user apparatus according to claim 3, wherein
the predetermined channel is at least one of an uplink shared channel, an uplink control channel, a sounding reference signal for uplink, a demodulation reference signal for uplink, and an uplink random access channel.

19. The user apparatus according to claim 4, wherein
the predetermined channel is at least one of an uplink shared channel, an uplink control channel, a sounding reference signal for uplink, a demodulation reference signal for uplink, and an uplink random access channel.

20. The user apparatus according to claim 5, wherein
the predetermined channel is at least one of an uplink shared channel, an uplink control channel, a sounding reference signal for uplink, a demodulation reference signal for uplink, and an uplink random access channel.

21. The user apparatus according to claim 6, wherein
the predetermined channel is at least one of an uplink shared channel, an uplink control channel, a sounding reference signal for uplink, a demodulation reference signal for uplink, and an uplink random access channel.
